(19) United States
(12) Patent Application Publication
(10) Pub. No.: US 2025/0252320 A1
(43) Pub. Date: Aug. 7, 2025

(54) IMPROVEMENT OF AI PREDICTIONS USING CONTEXT LOCALIZATION

(71) Applicant: Tellagence, Inc., Oregon City, OR (US)

(72) Inventors: Nitin Mayande, Naperville, IL (US); Sharookh Daruwalla, Austin, TX (US)

(73) Assignee: Tellagence, Inc., Oregon City, OR (US)

(21) Appl. No.: 18/755,410

(22) Filed: Jun. 26, 2024

Related U.S. Application Data
(60) Provisional application No. 63/550,504, filed on Feb. 6, 2024.

(51) Int. Cl. G06N 5/01; G06N 3/0475

(52) U.S. Cl. CPC G06N 5/01; G06N 3/0475

(57) ABSTRACT

A context localization system provides relevant local context to a user query to reduce hallucinations and/or inaccuracies for a generative AI system. In embodiments, a corpus of data may be accessed to provide relevant local context. A user query may be used to obtain relevant portions of the local data, which may then be summarized and combined with the user query to form an engineered prompt that include the relevant local context. The engineered prompt is then provided to a generative AI system. In some embodiments, the engineered prompt may allow for determining user sentiment. Other embodiments may be described and/or claimed.

### CROSS-REFERENCE TO RELATED APPLICATIONS

This application claims priority to U.S. Provisional Patent Application No. 63/550,504, filed on 6 Feb. 2024, the contents of which are hereby incorporated into this application by reference as if fully set forth herein.

### TECHNICAL FIELD

Disclosed embodiments are directed to artificial intelligence (AI) predictive systems, and in particular to use of context localization improve AI predictions and reduce hallucinations.

### BACKGROUND

Artificial intelligence (AI) technology continues to evolve into an increasingly useful tool that can be applied in a variety of different domains. AI technology includes a variety of different techniques and algorithm, including artificial neural networks (ANN). A subset of ANNs includes generative neural networks, and more particularly, large language models (LLMs), such as ChatGPT. For implementations such as ChatGPT, the LLMs are trained on vast amounts of textual data that may span a variety of different information domains. Other LLMs may be trained on more specific domains to form an expertise in a particular area. For example, some LLMs may be trained on social network data to provide predictive expertise on user behavior.

While the underlying implementations can vary, LLMs typically receive as input a query, such as a question in the form of one or more textual sentences. The query is then fed into an input layer of the LLM. Generally speaking, LLMs are prediction engines, such that an answer to a query is generated by predicting what a next word or token would be based on the data set used to train the LLM and, in some implementations, previous predictions. Some LLMs also consider previous queries in providing answers, such as when a user has a “conversation” with the LLM, asking follow-up questions in response to predictions generated from earlier queries.

LLMs are only one type of generative AI that is finding increasing use across a range of industries today. Other types of generative AI may include image generators, which can create synthetic images of widely different types based upon provided user prompts, as well as synthetic motion video. Some such generative AI can employ the likeness of existing people in creating entirely synthetic images and video. Still other examples of generative AI can include music generation, and multi-modal AI which may be able to generate a variety of different types of media in response to user prompts.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an example system for providing context localization to improve the accuracy and consistency of a generative AI system, according to various embodiments.

FIG. 2 is an expanded block diagram of the example system of FIG. 1, depicting the constituent components of the context localization block, according to various embodiments.

FIG. 3 is the diagram of FIG. 2 depicting the block components for context localization, according to various embodiments.

FIG. 4 is a flowchart of operations of an example method for context localization to improve the accuracy of a generative AI system, according to various embodiments.

FIG. 5 is a flowchart of operations expanding on the actions taken in the localize context operation of FIG. 4, according to various embodiments.

FIG. 6 is a block diagram of an example computer that can be used to implement some or all of the components of the disclosed systems and methods, according to various embodiments.

FIG. 7 is a block diagram of a computer-readable storage medium that can be used to implement some of the components of the system or methods disclosed herein, according to various embodiments.

### DETAILED DESCRIPTION

Generative neural networks are capable of generating outputs based on training datasets. In the case of LLMs, these training datasets are essentially any corpus that provides combinations of words put together to form sentences. A large amount of training data is usually used to train the models so that they can be used to generate a coherent output to a query provided to them. However, at the fundamental level, these models are typically using probability to predict what word(s) should be generated next. In most cases, this prediction is based on context, among other mathematical techniques. In these models, context is usually dependent on the token limit supported by the model, which is essentially the memory the model has to retain information. If the input query or data is longer than the token limit, then the information beyond that may be forgotten/ignored, or de-focused by the model. This is a common problem when dealing with data related to specific domains, e.g. social platforms. Despite these limitations, these models can be indispensable to fields such as Social Data Analytics, with capabilities including, but not limited to, summarization, sentiment analysis, etc. These capabilities can not only provide quick ways to process and digest large amounts of data, but can further be used to understand other macro trends such as public opinion, important issues to a specific generation or demographic which in turn can help stakeholders make informed and prudent decisions.

LLMs and other types of generative AI act as prediction engines. In the case of LLMs, generative models generate a predicted next letter, word, sentence, or other token in response to an input query, weights generated from a training data set and, in some implementations, past predictions and queries, such as where a LLM can engage in a conversational session with a user. Similarly, generative AI for images or video generate predicted patterns of pixels, structures, and/or features in response to an input query. However, one issue of current generative AI models and their predictive nature is the possibility of hallucinations. Hallucinations, which may occur when the AI's training and/or structure result in improper predictions from a given input, are essentially predicted results that are false, incorrect, misleading and/or nonsensical when the model's primary goal is to provide factual information. Hallucinations erode trust in the model to provide truthful and factual responses to a user query. While an AI model or system may be trained on factual data to help achieve a goal of factually-based responses, because it is nevertheless a prediction engine, it can make predictions that are not factually correct. Erroneous answers may depend on a given input query, and how the model is configured to weigh various parts of the query and other relevant data provided to the model's input layer along with the query.

In some scenarios, hallucinations may result from an insufficient training data set and/or insufficient use of the set during the training process (e.g. too few training epochs to achieve an acceptable accuracy rate). Such problems can usually be readily identified and corrected, e.g. by employing a larger and/or more refined training data set, increasing the number of training epochs, etc. However, as described above, in some scenarios hallucinations result from the model's focus mechanism failing to focus or process an input query and/or other query in a manner that aligns with the intent of the person creating the query, thereby resulting in an incorrect interpretation of a given query and/or query context. In such instances, the hallucinations may be addressed by careful construction of the query prompt, commonly known as prompt engineering. Prompt engineering may, in some situations, include supplying additional context to increase response accuracy. In some cases, a generally-trained AI model may be useful in relation to a corpus of local data, such as an organization's databases or other collections of institutional knowledge, domain-specific knowledge, etc. The corpus of local data itself can form a context.

Context, for purposes of a generative AI system or model, can be broadly thought of as any data relevant to a particular query that helps the generative AI correctly interpret the query, particularly when a query may be susceptible to multiple interpretations. For example, some phrases may be used literally or idiomatically, e.g. “I turned red” could mean a person literally turned red, such as from a sunburn, or could be used colloquially to mean the person is embarrassed. Many acronyms may have multiple possible meanings, e.g. asking “What are the FARs?” could be referencing Federal Acquisition Regulations, or Federal Aviation Regulations. Contextual information may allow resolution of these ambiguities. By further way of example, where generative AI is conversational, such as where a user of an LLM can submit follow-up queries in response to a generated answer, the context may include all previously submitted queries along with the corresponding answers from the LLM. In such use cases, the LLM may indicate an ambiguity or assume a particular meaning, and the user may issue a follow-up response clarifying the intended meaning; this exchange forms a context that allows resolution of the ambiguity. By resolving the ambiguity, the LLM is significantly more likely to provide accurate and relevant answers.

As used herein, the term “local data” refers to any information that can form a context (regardless of whether used as such) for queries to a generative AI or ML system. Such information may include, but is not limited to, organizational databases, social media feeds, proprietary data regardless of format, data that may be relevant to an organization or user regardless of source, and the like. “Local” thus refers to relevance to a particular user, group of users, organization, or the like, as opposed to any random given user of the generative AI or ML system. “Local” is not being used herein in a geographic or physical locality sense.

In other examples, a business or organization may employ a generative AI system to solve business problems. Many organizations also have a body of institutional knowledge relevant to their work or purpose, and this body of knowledge can form a context for a generative AI system. Absent this body of knowledge, a generative AI may provide answers to questions that are partially or wholly irrelevant to solving a given business problem and/or require a user to supply appropriate context with each interaction. To use the above example of “What are the FARs?”, a user of a generative AI who works for a flight school who poses this question is most likely interested in the Federal Aviation Regulations, as such regulations are particularly relevant to the flight school's business. If the generative AI is initially made aware that the query is coming from a user working for a flight school, the generative AI can more readily provide a relevant answer, rather than seek to resolve what is meant by “FARs”. This information can be provided via a database of relevant business information. Similarly, a lawyer who uses generative AI for legal research runs a risk that the generative AI may hallucinate legal cases that do not actually exist. However, by providing context such as the requirement that legal citations must be from actual cases handed down by courts, the generative AI system may be able to avoid hallucinating false cases, and provide only citations to genuine cases.

This use of a local corpus of data is a type of context localization. A recurring issue in context localization and resolution of ambiguities is the question of similarity of texts, which can imply relatedness. Related texts can suggest relevant contextual material, such as where a query to a generative AI is similar to a heading or title of a document. The similarity suggests that the document may be particularly relevant to a response to the query, and so should be considered as context. Similarity between texts may be addressed with two different approaches: syntactic similarity, and semantic similarity. Syntactic similarity focuses on the structure of the text, i.e., looking at word order, grammar, and sentence construction, etc., without considering the meaning of the words themselves. Conversely, semantic similarity focuses on the meaning conveyed by the text, i.e., the underlying message or idea, regardless of the specific words or structure used. Each type of similarity may find different usefulness depending on the nature of a given query.

Disclosed embodiments include a context-localization mechanism to help generative AI models, such as (but not limited to) general purpose publicly available generative AI systems like ChatGPT, Google's Gemini, Microsoft's Copilot, OpenAI's DALL-E, and the like, and/or specialized, customized, or privately owned or developed generative AI systems, focus their attention on the correct context, thereby reducing the potential for hallucinations in their response. In one sense, disclosed embodiments act to guide target generative AI models via contextualized input to avoid possible hallucinations and improve prediction consistency. More specifically, in some embodiments, the context-localization mechanism engages in automatic prompt engineering with reference to both prompt query as well as establishing additional context from a database or other source or corpus of local data that is relevant to context. In particular embodiments, an input prompt is processed with respect to the local data, and reformulated (engineered) into a prompt that will properly focus the attention of the generative model. In some embodiments, a clustering algorithm is employed to group local data with a similar context, thereby guiding the model to focus on such similar context when processing the query or data. Summarization may also be employed in some embodiments, such as on the local data, to assist in prompt engineering. Once the prompt or query has been re-engineered with respect to local data context, it may be passed to the generative AI model for processing and obtaining results. Other embodiments may vary, and will be discussed below.

It will be understood by a person skilled in the relevant art that achieving a 100% accurate prediction rate is, at least for the moment, not achievable. The goal is to reduce hallucinations and improve predictive accuracy and consistency as much as possible, while maximizing prediction accuracy.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

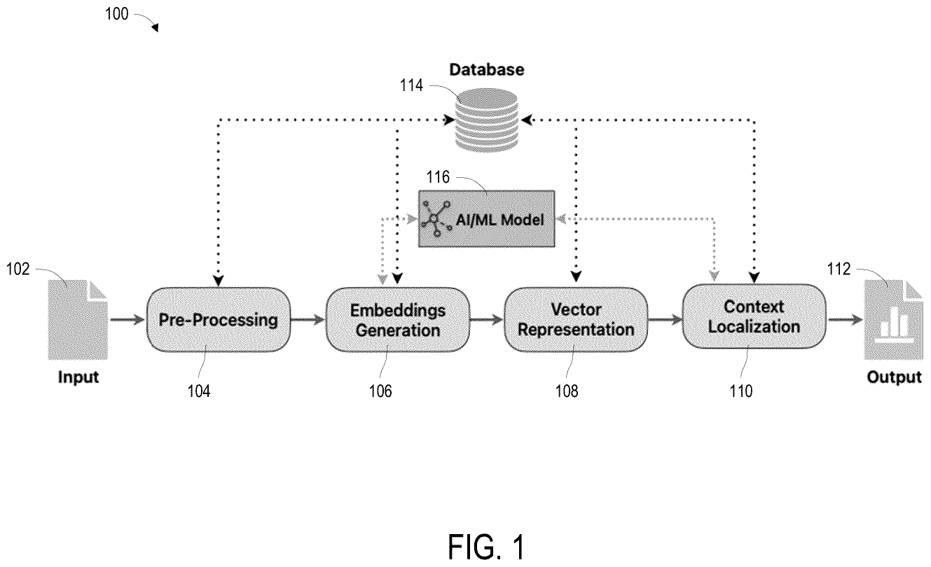

FIG. 1 illustrates a block diagram of a system 100 for providing context localization for a generative AI system, such as a large language model. System 100 starts with an input query 102, which may be received from a user. Input query 102 may be in any suitable format that can be process by system 100. In some embodiments, the format of input query 102 will depend on the requirements of the subsequent blocks of system 100 and/or the requirements of the generative AI model that is used to provide final results. For example, input query 102 may be text prompt, an image, a sound, a file, or any other data type suitable to act as a prompt for the generative AI model used with system 100. In some embodiments, input query 102 may be multi-modal, viz. capable of receiving a prompt of a variety of different data types and/or a mixture of data types (e.g., a text prompt that includes an image or a sound). It should be understood that the generative AI model need not output a query answer that is in the same mode as the input query 102. For example, input query 102 may be a text prompt that is provided to a generative AI that produces images; the resultant image would be based on the textual request.

Following receipt of input query 102, the input query is passed to a pre-processing block 104 for any necessary cleaning and preparation. Following pre-processing, the pre-processed input query 102 is passed to an embeddings generation block 106 for mapping to a vector space, which is then passed to a vector representation block 108. The vector representation and resultant mappings are then passed to a context localization block 110, which reformats the process input query 102 into a query for a generative AI model (not shown) that includes necessary context to allow the generative AI model to provide accurate results that are relevant to the query, and minimize any hallucinations. In response to the query, the generative AI model provides appropriate results.

Further providing input to the system 100, in various embodiments, are a database 114 and AI/ML model 116. Database 114, in embodiments, may contain a corpus of information for context localization, such as local data relevant to a particular operator or user of an implementation of system 100. For example, a corporation implementing a system 100 may provide database 114 with various relevant business documents and materials that form a context for any queries made to a generative AI system

Depending on the nature of the generative AI model and the specifics of a given embodiment, the flow of system 100 may be iterative. For example, where a LLM system is employed that can engage in a conversation (such as, e.g., ChatGPT), the sequence of blocks of system 100 may be repeated iteratively as multiple prompts are issued by a user during a conversation session. Each successive interaction with system 100, in such an example embodiment, may be handled as a new input query 102, with previous queries 102 and resultant responses forming a progressive context. Likewise, in some embodiments system 100 may prepare a corpus of information for context localization, such as may be in database 114, in advance of receiving and processing any input queries 102, or in other embodiments may process information from the corpus of information only as needed and determined by a given input query 102.

The particular processing approach taken may depend upon the specifics of a given implementation of system 100. In some embodiments, some of the blocks of system 100 may be performed in advance on any corpus of information or other set of data for context localization, while other blocks may be performed on the fly in response to a query. For example, context localization block 110 would typically be performed on the fly in response to a given query as it results in an engineered prompt and context to dispatch to a generative AI model, while the other blocks may have been performed ahead of time on the corpus or data for context localization for efficiency and time savings. For a given prompt, the blocks of system 100 may be performed on the fly, with the blocks of system 100 (save for context localization block 110) having been earlier performed on the corpus or data for context localization.

Pre-processing block 104, in embodiments, receives each input query 102 as data and prepares it for subsequent embedding generation. Pre-processing data, prior to any analysis or processing into vector embodiments, prepares the data to be consumed in an expected and deterministic manner, such as by reformatting data to comply with a consistent format for acceptance by the embeddings generation block 106. In some embodiments, pre-processing is crucial before doing any data analysis as the generative AI models that are eventually queried will use the provided data to learn features of the data. Pre-processing thus helps ensure that the quality of features extracted is optimal, and helps to avoid common hurdles in AI/ML models such as parameter over-fitting or under-fitting. In various instances, pre-processing may be carried out using any pre-processing technique known in the relevant art, or that may be subsequently developed, that is suitable for the AI/ML models being employed with system 100. Depending on the specifics of a given embodiment or instance, pre-processing may be minimal or unnecessary.

Furthermore, in some embodiments, pre-processing block 104 may also receive local data from database 114, to facilitate providing local context that is relevant to the input query 102. In various embodiments, this preprocessing may be of a similar or identical nature to the pre-processing carried out on the input query 102. In embodiments, pre-processing of the local data may be carried out as a preparatory step prior to system 100 being put into use and accepting an input query 102. In other embodiments, pre-processing of local data may be carried out on the fly as system 100 is in use. In still other embodiments, existing local data may be pre-processed as an initial step before system 100 is in use, with subsequently obtained local data pre-processed on the fly or as acquired, such as where local data changes and/or is added to in the normal course of business.

Non-limiting examples of pre-processing that may be carried out in pre-processing block 104, in embodiments, include data de-duplication and/or cleaning by removing unnecessary and potentially confusing information that is not required for the end-goal analysis of context localization, and normalizing data forms, such as rearranging the order of data into a consistent fashion. Some examples of information removed from data by pre-processing block 104 may include punctuations, stop-words, hyperlinks, duplicated words, etc., for example. In some embodiments, pre-processing block 104 may further correct typographic and other minor clerical errors. The information to be stripped may vary depending upon the specifics of a given embodiment, e.g., in some cases hyperlinks may be relevant, and so kept.

In some embodiments, the actions of pre-processing block 104 may be determined by the nature of the input query 102 and/or data from database 114. For example, a query directed to or implicating web-based resources may benefit from the retention of hyperlinks, while a simple question seeking knowledge may benefit from the removal of hyperlinks. In other examples, a question seeking knowledge may be structured or phrased in a format that a selected generative AI model may not be able to accept; pre-processing block 104 may restructure the query into a format appropriate for the selected generative AI model. In such embodiments, a user may be able to select a desired generative AI model along with the input query 102, which the pre-processing block 104 may then use to direct reformatting. Pre-processing block 104, in embodiments, may thus determine from the input query 102 how best to clean the data. In still other examples, the local data from database 114 may be used by pre-processing block 104 to restructure the input query 102 into a format that best aligns with the local data.

Further, where input query 102 is of a different mode than text, such as an image, file, or sound, pre-processing block 104 may engage in a different set of functions depending upon the specific input mode. For example, if input query 102 is an image, pre-processing block 104 may detect and strip out irrelevant water marks or image noise, or may process the image such as with an edge detection algorithm, adjust contrast, flatten layers, de-colorize, resize or resample, etc. The specifics of the operations pre-processing block 104 carries out may depend upon the mode of the input query 102, the requirements of the target generative AI, and/or the requirements of subsequent blocks of system 100, such as the input requirements of AI/ML model 116 if used to generate embeddings in the embeddings generation block 106, discussed below.

In some embodiments, the local data from database 114 may be pre-processed by pre-processing block 104 as an initialization step for system 100 prior to receiving an input query 102. In such embodiments, pre-processing block 104 may be guided in its actions by the local data. The actions of pre-processing block 104 on the local data may be identical to those described above with respect to the pre-processing of input query 102. In still other embodiments, local data is also pre-processed by the pre-processing block 104, which may vary in processing based on the nature and structure of the input query 102. In such embodiments, the local data may be repeatedly pre-processed on the fly by pre-processing block 104 in response to various input queries 102 of differing nature.

Embeddings generation block 106, in embodiments, accepts the cleaned and formatted data resulting from the actions of pre-processing block 104 and generates embeddings of the data, for embedding into a vector space. In some instances, embeddings are vector representations of the words/sentences that capture the meaning of the data, which may be semantic and/or syntactic, depending upon the specifics of a given implementation. Embeddings, in some implementations, are an array of fixed dimension vectors where each dimension value represents a particular characteristic of the data. These embeddings may be generated using one or more AI/ML models, such as AI/ML model 116. The generated embeddings may then be stored in a vector database that allows for efficient storage of vectors (of fixed or varying numbers of dimensions). A vector database enables efficient querying and retrieval of its contents. They allow for fast lookups, based on vector distances, while ensuring an ease of access anywhere in the process pipeline of blocks of system 100. The embeddings generation block 106, in embodiments, may operate on any and all data received from the pre-processing block 104.

The AI or ML model 116 may generate vector representations of data that reflects data similarity, for use as embeddings in the vector database. As discussed above, in embodiments similarity may be determined on the basis of syntactic similarity or semantic similarity. Data may be determined to be syntactically similar using various methods, such as word-level analysis, where shared words are counted, edit distance (the minimum number of changes required to transform one set of data into another) is determined, or n-grams (sequences of adjacent words) are evaluated; syntactic dependency parsing, where parse trees that represent the grammatical structure of sentences are compared; and/or term frequency-inverse document frequency, where the importance of each word in a data set is evaluated based on its frequency both within a text or data set, as well as across a broader data set or corpus. The foregoing are merely examples of possible algorithms or models that could be employed to determine syntactic similarity. Any suitable algorithm or model now known or later developed that can determine syntactic similarity to a degree acceptable for a given implementation may be used. Syntactic similarity analysis can lend itself to relatively straightforward algorithmic analysis, and may not necessarily require or benefit from implementation using a machine learning or AI model.

Data may also be determined to be semantically similar using various methods, such as word embeddings, where words are represented as vectors in high dimensional space, and similar words have closer vectors; WordNet, which employs a semantic network to relate words based on meaning categories; latent semantic analysis, where hidden topics are identified in data and similarity is determine based on shared topics; and/or Doc2Vec or Sentence2Vec, vector representations for entire documents, sentences, or other data sets are learned, to capture their broader meaning. The foregoing are merely examples of possible algorithms or models that could be employed to determine semantic similarity. Any suitable algorithm or model now known or later developed that can determine semantic similarity to a degree acceptable for a given implementation may be used. Furthermore, as suggested by the foregoing description, determining semantic similarity may be well-suited to implementation using an AI or ML model, which can be trained using appropriate data sets to generate vector representations based on semantic similarities.

As shown in the example system of FIG. 1, database 114 also links to embeddings generation block 106. Database 114, in some embodiments, may store pre-processed data resulting from pre-processing block 104, and so may supply the pre-processed data to embeddings generation block. Database 114 may also host or comprise a vector database, into which the embeddings generation block 106 (or the vector representation block 108, discussed below) may store the data embeddings.

Vector representation block 108, in embodiments, takes the embeddings generated by embeddings generation block 106 and creates one or more vector search indices. A vector search index defines a distance measure i.e. vector dimension length, which can be used for indexing the stored dataset along with any other additional features to help augment mixed retrieval (a combination of vector search with text search). A vector search index helps to perform an efficient similarity search with high dimensional vectors, similar to text search indices based on lexical similarity. A vector search index can be based on a number of distance measures such as: 1) Cosine or Normalized Dot-Product Distance-either are good for text data; 2) Euclidean Distance-good for numerical data; and/or 3) Any other suitable algorithm for determining similarity between related search terms, e.g. semantic similarity, syntactic similarity, etc. In some embodiments, the normalized dot-product is used as a distance measure.

It should be understood that the distance measure between embeddings in a vector search index may reflect the degree of similarity between the data that was used to generate each embedding. Accordingly, the distance measure between embeddings depends upon the method used to determine similarity, viz. whether the similarity is syntactic, semantic, or another measure. Where embeddings are calculated based on syntactic similarity, a short distance measure will indicate close syntactic similarity. Likewise, a short distance measure where embeddings are calculated based on semantic similarity will indicate close semantic similarity. In some embodiments, multiple vector search indices may be employed, such as a vector search index for syntactic-based embeddings, and a second vector search index for semantic-based embeddings. In some embodiments, results from both such vector search indices may be employed where similarity is evaluated using a hybrid of syntactic and semantic approaches. Depending on the specifics of how a given vector database and its associated vector embeddings are implemented, there may be a single vector database that stores embeddings that reflect syntactic similarity along with embeddings that reflect semantic similarity, with the database having a vector search index for the syntactically similar embeddings and a second vector search index for the semantically similar embeddings. In other embodiments, each type of similarity may have its own dedicated vector database and associated vector search index.

Once one or more vector search indices have been generated with vector representation block 108, context localization block 110, in embodiments, uses the vector search index or indices to generate a prompt reflective of the input query 102 that includes local data. The resulting engineered prompt, output 112, may then be passed to a generative AI or ML system, where the included local data of output 112 reduces the possibility of a hallucination or an irrelevant answer. The vector search index/indices from vector representation block 108 may be used to retrieve local data from database 114, in conjunction with any vector embeddings of the input query 102, to generate the output 112; this is indicated by the connection in FIG. 1 between database 114 and context localization block 110, to supply local data. Depending on the needs of a given embodiment and the target generative AI, the local data from database 114 can be in a raw format or a processed format (such as from pre-processing block 104), in a vector representation format, or in another format appropriate for the needs of a given implementation. Either context localization block 110 or another processing block (not shown) may format the engineered prompt into a suitable format for output 112, to be received by the target generative AI.

Output 112, following generation, is then passed to a target or intended generative AI system (not shown). Depending on the nature of the generative AI system, the results returned from the generative AI system may be fed back into system 100 to form part of the local context, such as when the generative AI system is a LLM where a user can engage in a conversation session. The results may be fed back to pre-processing block 104 and/or stored into database 114. In some embodiments, the results may be stored in a temporary storage, as the answers from the generative AI system may only be relevant to a given conversation session, and then deleted once complete. In other embodiments, the answers may be stored for a longer or more indefinite period, such as when the answers are intended to become part of the corpus of data used for context localization, e.g. the generative AI creates answers or material that the user wishes to incorporate into the corpus as local context for future interactions.

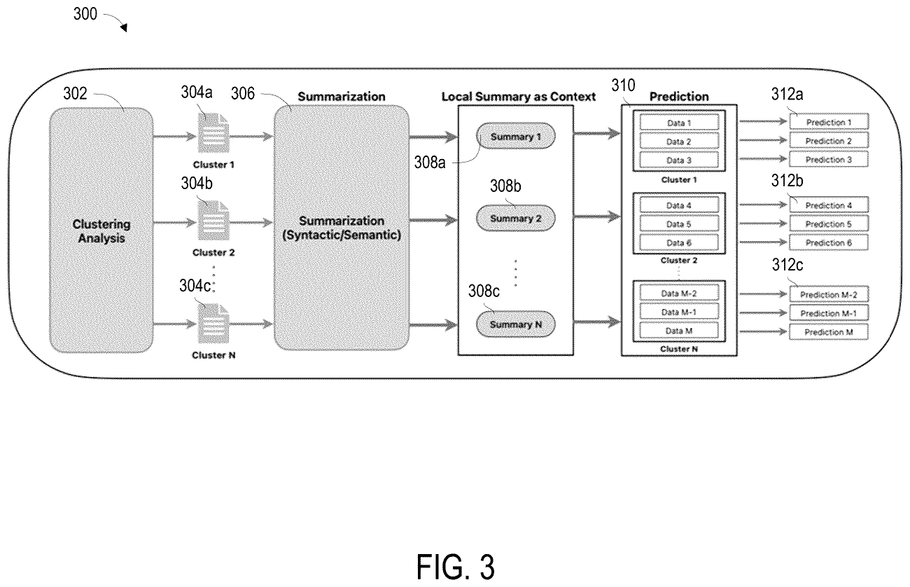

Context localization block 110, in some embodiments, first performs a clustering analysis to group semantically, syntactically, and/or contextually similar data together. Each cluster may then be summarized individually, using one or more AI/ML models, such that all the data points within a given cluster are arranged to form a single summarized datapoint. The AI/ML models may be AI/ML model 116. These summarized data points may then be passed to the models along with a carefully designed input prompt to instruct the exact procedure that needs to be followed (e.g. generating the sentiment of the summarized datapoint). The various components and process flow of context localization block 110 will be discussed in greater detail below, with respect to FIG. 3.

Database 114, as has been discussed above, may comprise a single data store, or multiple data stores, of similar or different types. In one possible aspect, database 114 may house relatively large quantities of unstructured data, such as a corpus of business data. This unstructured data may be processed by system 100 in batches, in a single task, or on demand, depending upon the needs of a given implementation. Database 114 may also include one or more vector databases, such as is used with embeddings generation block 106 and vector representation block 108. In some embodiments, database 114 may include a vector database for vector search indices that are based on syntactic similarity, and a vector database for vector search indices that are based on semantic similarity. Database 114 may further include one or more additional data stores that may be used for temporary data, such as cleaned data resulting from pre-processing block 104, embeddings generated by embeddings generation block 108, and/or engineered prompts and context information for context localization block 110. Other stores may be a part of database 114 as determined by the needs of a given implementation. Database 114 may be implemented using any database technology or technologies, now known or later developed, that are suitable for the various functions of database 114 as part of system 100, and depending upon the needs of a specific embodiment.

AI/ML model 116, as described above and illustrated in FIG. 1, may interact with embeddings generation block 106 to create vector representations of the local data and/or input query 102 for embedding into the vector database and incorporation into one or more vector space indices. AL/ML model 116 may also interact with context localization block 110 to summarize contextual data, as will be discussed further below. AI/ML model 116 may be implemented using any AI or ML model suitable to carry out or assist with the functions of at least the embeddings generation block 106 and/or the context localization block 110. As will be understood, the AI or ML model may need to be first trained and/or tuned to accurately carry out its functions. In some embodiments, multiple AI/ML models may be employed as part of AI/ML model 116. For example, where system 100 employs both syntactic and semantic similarities, two different models may be employed, each trained or designed to provide vector representations that map into a vector space based, with one creating vector representations based on syntactic similarity, and the other creating vector representations based on semantic similarity. In some embodiments, the target generative AI model to receive the context-localized input prompt from context localization block 110 may be a part of AI/ML model 116. In other embodiments, the target generative AI model may be separate from AI/ML model 116, such as where system 100 is used as a front end to query into a general purpose generative AI system, such as ChatGPT, Gemini, Copilot, DALL-E, or the like.

It should be understood that system 100 may be implemented locally to a particular user or organization, on one or more servers on the premises or under the control of the user or organization. In other embodiments, system 100 may be implemented using remote servers, such as cloud-based services that are accessible over a wide-area network, such as the Internet. In still other embodiments, one or more of the various blocks of system 100 may be implemented on local server(s), with other blocks implemented on remote servers or using cloud-based services, resulting in a hybrid implementation of system 100.

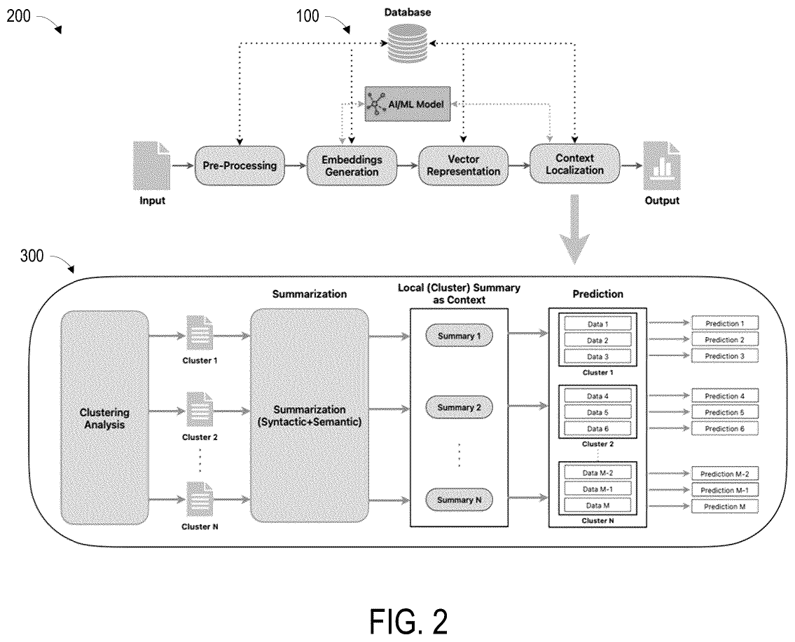

FIG. 2 is an overall visualization of a system 200, and illustrates both the blocks of system 100, and the specific blocks of the context localization block mentioned above, illustrated as process flow 300. Process flow 300 for context localization includes various operations to be performed on an input query and local data, including clustering analysis, summarization, and prediction. Thus, system 200 illustrates the flow of operations of a context localization system that interfaces with a generative AI system, and provides an overall picture of the functional aspects of possible embodiments of a context localization system.

Turning to FIG. 3, the various components of the process flow 300 for a context localization, such as may be implemented by context localization block 110 (FIG. 1) are illustrated. Process flow 300 begins with a clustering analysis 302, which results in one or more clusters 304a to 304c. It should be understood that the three illustrated clusters 304a, 304b, and 304c (generically, clusters 304) are merely an example; clustering analysis 302 may result in fewer or more clusters depending upon the nature of the data being processed and the specific requirements of a given implementation. The clusters 304 may then be summarized in a summarization operation 306, resulting in local summaries 308a, 308b, and 308c (generically, local summaries 308) that are useable as a context for a prompt to a generative AI, such as output 112 (FIG. 1).

In clustering analysis 302, in some embodiments, once vector search indices have been created, relevant local data is formatted into similar clusters using one or more clustering algorithms. The vector search indices may result from vector representation block 108 (FIG. 1). In embodiments, relevant local data may be obtained from the corpus of local data by using the input query 102 (FIG. 1). The input query 102, which may be converted into vector representations, is used to search into the one or more vector search indices generated in the vector representation block 108. The search(es) may return local data that is most relevant to the input query 102.

In embodiments, one or more clustering algorithms may be used in conjunction with the vector search indices to determine the relevant data from the corpus of local data. Examples of clustering algorithms that may be employed include Hierarchical Small Navigable World (HSNW), k-means, or any other algorithm now known or later developed that is suitable for use with a given implementation of system 100 and process flow 300. Essentially, in some embodiments, the clusters 304 of vertices generated from local data embeddings are each defined as being within a predetermined threshold of a given target vertex generated from the input query 102. This helps ensure that the clusters 304a to 304c that are formed are semantically, syntactically, and/or contextually similar. Cluster IDs may then be assigned to each cluster and/or the vertices (or datapoints) that comprise each cluster, which then may be stored in the database 114 (FIG. 1). The end result is a series of clusters 304a to 304c that reflect various points of data most relevant to the input query 102, within the corpus of local data.

Once the clusters 304a to 304c are determined, in embodiments, they may be summarized in summarization operation 306. As noted in the depicted example in FIG. 3, summarization may involve syntactic analysis, semantic analysis, or a combination of both. Summarization, by definition, is the act of preparing a brief and succinct summary of a much larger corpus. Its primary advantage is that it provides the same pertinent and accurate information as the underlying data, but in a more compact and easily digestible package. For computing purposes, summarization can reduce the required overhead of system resources for processing and so decrease processing time, memory usage, and power consumption.

The underlying context of each cluster 304 may be individually summarized using an AI/ML model, such as AI/ML model 116, discussed above with respect to FIG. 1. All data points within each cluster 304 may be arranged to form a single text data point, coupled with a carefully designed input prompt, before inputting them into the AI/ML model 116. In some instances, the input to the AI/ML model 116 may comprise a context and a prompt. The context may be the summary of each cluster 304, of all datapoints within that cluster. The carefully designed input prompt may comprise a set of instructions to the AI/ML model 116 on what analysis needs to be performed. In embodiments, the summarization capability of the AI/ML model 116 may use an abstractive approach such that large text/datapoints are converted into a few sentences that capture the context (or most pertinent details) relevant to the input query 102 that is seen across the corpus of local data.

These sentences from AI/ML model 116 comprise the local summaries 308, with each of the local summaries 308 corresponding to each of the clusters 304, viz. cluster 304a corresponds with summary 308a, cluster 304b corresponds with summary 304b, etc. Depending upon the functionality of AI/ML model 116 and/or other components of system 100, the various vector representations of the relevant contextual data may be used to obtain the original raw data of the corpus of local contextual data, and/or to reference the original data for purposes of generating the summary sentences. It should be appreciated that while the foregoing example contemplates a text mode of input, this disclosure is not intended to be limited to only text-mode based systems. In other embodiments, different modes of entry (e.g. images, sounds, files, etc.) may be utilized. The input prompt(s) and/or the resulting summary may likewise be in a different mode. In still other embodiments, the resulting summary could be in a different mode from the input prompt(s), with the format and mode of the resulting summary determined by the requirements of the target generative AI system.

In some embodiments and depending upon the specifics of a given implementation of AI/ML model 116, the summarization pipeline may include a Map-Reduce approach when individual clusters 304 are too large to completely fit within the token limit size of AI/ML model 116. In some such embodiments, clusters 304 may be divided into smaller sub-clusters, with specified character overlap, based on a predefined token size. This division operation is known as Map. The sub-clusters may then be summarized iteratively, and their summaries combined to form a new summary data point. This summarization and combination operation is known as Collapse. The Collapse operation is repeated until the newly generated summary data point(s) is/are reduced into a single summary. This final reduction operation essentially provides a summary-of-summaries and is known as Reduce. The Map-Reduce summarization thus provides a scalable approach; since the sub-clusters are independent, the AI/ML model 116 can be configured to run in parallel on the individual sub-clusters. Once summarization for each cluster is completed, the summaries are propagated back to the database 114.

Once the various local summaries 308 are obtained, they may be used to obtain one or more desired predictions in prediction operation 310. The predictions of prediction operation 310 may be any desired analysis or prediction that the target ML model is capable of providing. As may be understood, the nature of such predictions may be constrained by the chosen target ML model. For example, in instances where the target ML model is an LLM, the prediction may be a text-based answer to the prompt. Similarly, in instances where the target ML model is an image generator, the prediction may be a desired image, rendered with consideration given to local context. Some possible use cases may also include, but are not limited to, sentiment analysis, summarization, translation, audience targeting, marketing, and the like.

In some specific examples, such as where the local contextual data is (or is derived from) social media data, the prediction may be a summarization, or sentiment prediction or analysis, to name a few possibilities. In such an example, sentiment analysis or prediction, at a fundamental level, predicts the sentiment of the underlying information. Sentiment can be as simple as positive, negative, or neutral, or more complex or custom in nature. Predicting summarization and/or sentiment analysis for extremely large datasets, such as raw data feeds from a social media platform, coupled with ever changing communication style, is a non-trivial exercise, even when just for the English language. In the case of social media feeds, sentiment analysis or prediction involves analyzing social platform datasets to extract the underlying sentiment within the dataset interactions. Considering the relatively massive size of raw data from a social media feed, the amount of processing power and time required to perform sentiment prediction on the raw data would be immense, and potentially impossible to accomplish except on relatively high powered systems. However, context localization process flow 300 allows prediction operation 310 to be accomplished with considerably more modest equipment requirements.

In examples that are used for sentiment analysis (among other possible uses), summarizing the clusters from summarization operation 306 makes generating a sentiment prediction from the local summaries 308 simpler and accurate. With a carefully designed prompt that incorporates the localized context, instructions and individual data points, as discussed above, all combined as input, prediction operation 310 can generate Positive, Negative, or Neutral sentiment predictions 312a, 312b, and 312c (generically, sentiment predictions 312) for each corresponding local summary 308a, 308b, and 308c. In some embodiments, the sentiment predictions 312 may be generated by passing the carefully designed prompt to AI/ML model 116. In other embodiments, the sentiment predictions 312 may be generated by the target generative AI (which, it should be recognized, may be a part of AI/ML model 116 in some implementations). Furthermore, in still other embodiments, multiple local summaries 308 may be aggregated to form a single sentiment prediction 312. Along with sentiment predictions 312, the AI/ML model 116 (or target generative AI model if separate) may also provide a detailed explanation of the reasoning used to create the sentiment predictions 312. In some implementations, both the sentiment predictions 312 and associated reasoning may stored back into the database 114 for later use, such as for future reference and/or to become part of the local data.

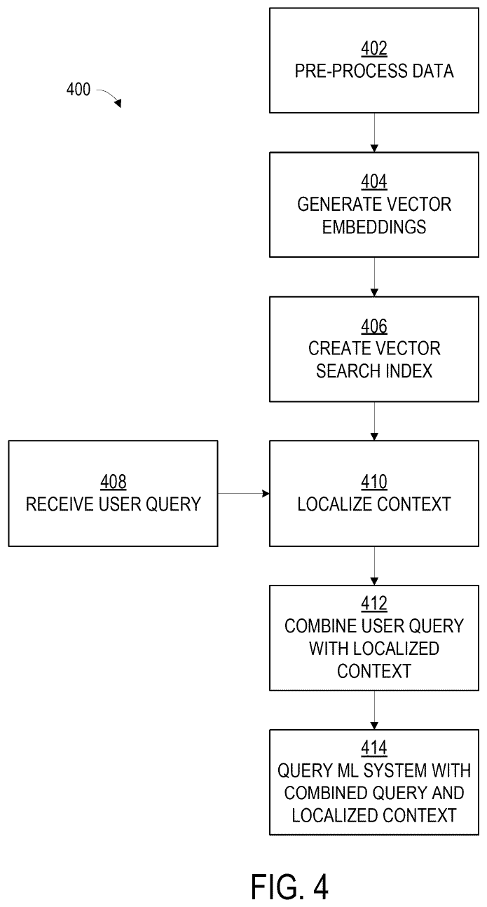

FIG. 4 is an example method 400 of the operations for context localization of a query to a generative AI system. The operations of method 400 may be carried out in whole or in part, depending upon the needs of a given embodiment. Further, some operations may be omitted, some operations may be added, and the order of operations may be rearranged depending upon the requirements of a given embodiment. The operations of method 400 may be carried out by one or more components of a system, such as system 100 (FIG. 1). Some or all operations may be carried out by a server, or by a device within the structure, or both. Much of the functionality described below in each operation corresponds with various blocks and modules described above with respect to FIGS. 1 and 2, and the reader is directed to the foregoing description of the same. Moreover, some aspects of a given operation may be instead carried out as part of a different operation, depending upon the specifics of a given implementing system.

In operation 402 of the example embodiment, local data, such as from a corpus of data relevant to a user or implementing organization, is pre-processed to provide a consistent format for subsequent processing, such as with pre-processing block 104. As discussed above with respect to FIG. 1, pre-processing may include reformatting or restructuring the data to comply with rules for consistency, removing duplicate information and/or words, correcting typographic errors, stripping punctuation, removing hyperlinks or other metadata (if not relevant or needed) etc.

In operation 404 of the example embodiment, embeddings in the form of vector representations are generated from the pre-processed data. The embeddings may be generated using one or more ML or AI models. In some embodiments, the selection of ML or AI model may depend upon the nature of the local data and/or the nature of a desired output from a target generative AI system. The vector representations are then embedded into an appropriate vector space that can capture and relate the similarity of embeddings within the space, with the embeddings stored into a vector database.

In operation 406 of the example embodiment, one or more vector search indices are created from the embeddings for the vector database storing the embeddings, to enable efficient searching of the embeddings within the vector space. The vector search indices, in embodiments, allow for efficient and relatively rapid retrieval of embeddings of the local data in response to a query. The query may come from a user query, in some examples, to retrieve those portions of the local data that are particularly relevant to the query. The vector search indices may also facilitate determining similarity of the retrieved local data.

In operation 408 of the example embodiment, a user query is received that is intended to be answered by a target generative AI system. The user query is to be context localized, so that the generative AI system provides an answer with increased accuracy, and with the chance of a hallucination significantly reduced, or even prevented. While not reflected in FIG. 4, as discussed above with respect to FIG. 1, the user query may also be passed through operations 402 through 406, to result in a vector representation or representations of the query. This representation may be used to search with the vector search indices from operation 406 to retrieve relevant local context. In some embodiments, the user query may be placed into another type of format (other than a vector representation) that is acceptable for searching into the vector search indices. How a user query is processed may depend upon the needs of a given embodiment of method 400.

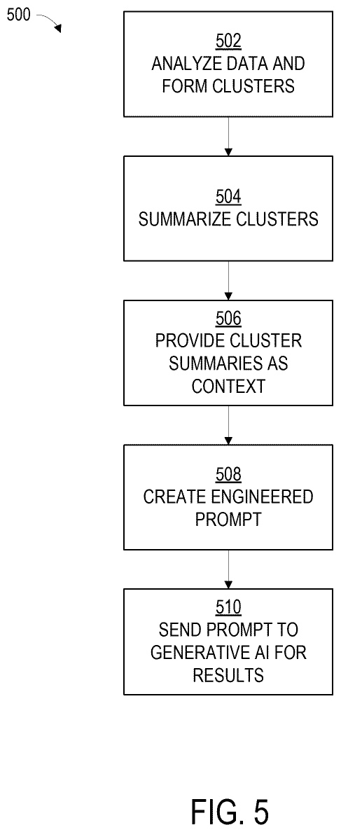

In operation 410 of the example embodiment, the user query is processed and local context is generated from relevant local data. The operations for determining or generating the local context will be described in greater detail with respect to FIG. 5, below. In some embodiments, the local context may be generated as a summary of the relevant local data.

Following generation of the local context, in operation 412 of the example embodiment, the user query is combined with the localized context to generate an engineered prompt for the target generative AI system. This engineered prompt includes both the user query and the relevant local data (or a summary of the same), and may be formatted so that, when supplied to the target generative AI system, the generative AI system's attention mechanism will focus on relevant query portions and provide an accurate response. This engineered prompt should ideally avoid or resolve any possible ambiguities that may have existed in the user query as received in operation 408.

In operation 414 of the example embodiment, the engineered prompt from operation 412 is submitted to the target generative AI system, combining the user query and (summarized) local context. The target generative AI may then respond in kind.

It should be understood, as discussed above with respect to FIG. 1, that the operations of method 400 may be performed iteratively, in whole or in part. In some embodiments, operations 402 through 406 may be performed on all of the local data prior to an implementing system receiving a user query. In other embodiments, operations 402 through 406 may be performed on-demand, such as if storage or processing power is at a premium, and/or it is otherwise infeasible to process the entire corpus of local data. Furthermore, the operations of method 400 may be performed iteratively from the responses from the generative AI and subsequent user queries, where the target generative AI system engages in a conversation session with a user.

FIG. 5 is an example method 500 of the operations for determining local data and preparing the engineered prompt that includes local context for a generative AI system. More specifically, method 500 is an example method that could be carried out to fulfill parts or all of operations 410, 412, and/or 414 of method 400 described above. The operations of method 500 may be carried out in whole or in part, depending upon the needs of a given embodiment. Further, some operations may be omitted, some operations may be added, and the order of operations may be rearranged depending upon the requirements of a given embodiment. The operations of method 500 may be carried out by one or more components of a system, such as the context localization block 110 of system 100 (FIG. 1), including the various operations of process flow 300 (FIG. 3). Some or all operations may be carried out by a server, or by a device within the structure, or both. Much of the functionality described below in each operation corresponds with various blocks and modules described above with respect to FIGS. 1 and 3, and the reader is directed to the foregoing description of the same. Moreover, some aspects of a given operation may be instead carried out as part of a different operation, depending upon the specifics of a given implementing system.

Following searching of one or more vector search indices to determine those data points in the vector database that correspond to local data that is the most similar and/or most relevant to an user query, in operation 502 of the example embodiment, the data points are analyzed to form clusters. The clusters, as described above with respect to FIG. 3, may each center around a data point from the user query. A user query may result in one or more data points, depending upon its complexity and constituent components. Any suitable algorithm for generating clusters may be employed. The clusters may reflect syntactic and/or semantic similarity to various aspects of the user query.

In operation 504 of the example embodiment, the clusters may be summarized to create a similar data point. As with clustering, the summarization process may rely upon syntactic similarity, semantic similarity, and/or both to generate a summary data point. In some embodiments, the summarized clusters may be split into overlapping sub-clusters which are then each summarized, with the sub-cluster summaries then being combined and summarized themselves. This splitting and re-summarization may be employed when the number and/or size of the summaries is too large or unwieldly to provide results that are sufficiently efficient and/or timely for a given implementation.

In operation 506 of the example embodiment, the cluster summaries are then combined with the user query to form the context for the query. This combination, in operation 508 of the example embodiment, may then be used to create an engineered prompt for the target generative AI system, such as in operation 412 of method 400, described above.

Finally, in operation 510 of the example embodiment, the engineered prompt is sent to the target generative AI system, such as in operation 414 of method 400. In some embodiments, the generative AI system may be used to determine user sentiment or otherwise respond to queries about sentiment.

As with method 400, one or more operations of FIG. 5 may be performed iteratively, such as where the target generative AI system engages in a conversation session.

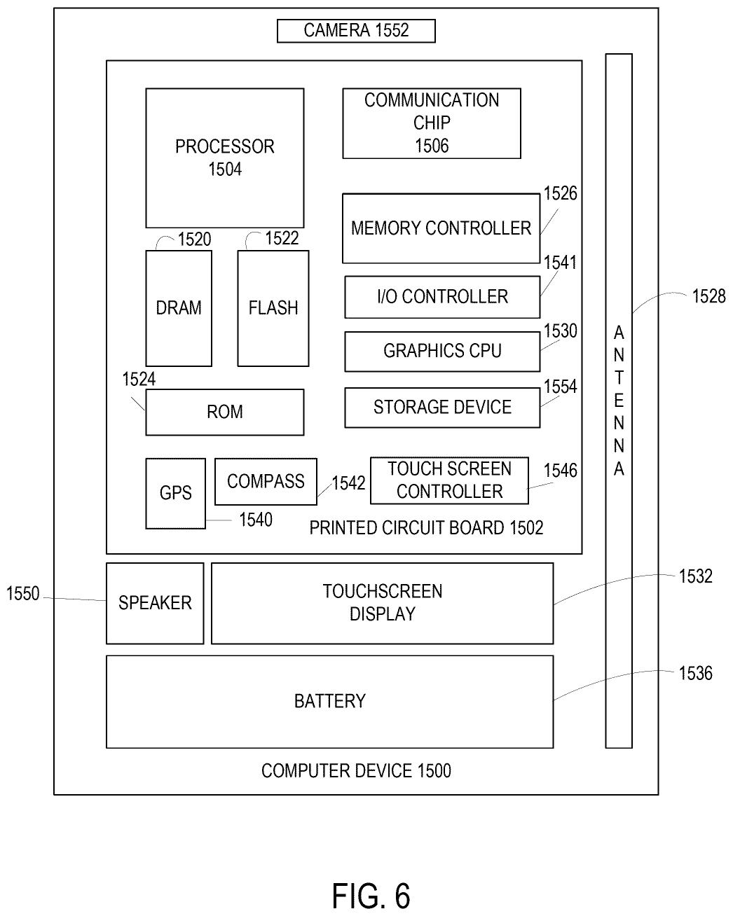

FIG. 6 illustrates an example computer device 1500 that may be employed by the apparatuses and/or methods described herein, in accordance with various embodiments. As shown, computer device 1500 may include a number of components, such as one or more processor(s) 1504 (one shown) and at least one communication chip 1506. In various embodiments, one or more processor(s) 1504 each may include one or more processor cores. In various embodiments, the one or more processor(s) 1504 may include hardware accelerators to complement the one or more processor cores. In various embodiments, the at least one communication chip 1506 may be physically and electrically coupled to the one or more processor(s) 1504. In further implementations, the communication chip 1506 may be part of the one or more processor(s) 1504. In various embodiments, computer device 1500 may include printed circuit board (PCB) 1502. For these embodiments, the one or more processor(s) 1504 and communication chip 1506 may be disposed thereon. In alternate embodiments, the various components may be coupled without the employment of PCB 1502.

Depending on its applications, computer device 1500 may include other components that may be physically and electrically coupled to the PCB 1502. These other components may include, but are not limited to, memory controller 1526, volatile memory (e.g., dynamic random access memory (DRAM) 1520), non-volatile memory such as read only memory (ROM) 1524, flash memory 1522, storage device 1554 (e.g., a hard-disk drive (HDD)), an I/O controller 1541, a digital signal processor (not shown), a crypto processor (not shown), a graphics processor 1530, one or more antennae 1528, a display, a touch screen display 1532, a touch screen controller 1546, a battery 1536, an audio codec (not shown), a video codec (not shown), a global positioning system (GPS) device 1540, a compass 1542, an accelerometer (not shown), a gyroscope (not shown), a depth sensor 1548, a speaker 1550, a camera 1552, and a mass storage device (such as hard disk drive, a solid state drive, compact disk (CD), digital versatile disk (DVD)) (not shown), and so forth.

In some embodiments, the one or more processor(s) 1504, flash memory 1522, and/or storage device 1554 may include associated firmware (not shown) storing programming instructions configured to enable computer device 1500, in response to execution of the programming instructions by one or more processor(s) 1504, to practice all or selected aspects of system 100, system 200, process flow 300, method 400, or method 500 described herein. In various embodiments, these aspects may additionally or alternatively be implemented using hardware separate from the one or more processor(s) 1504, flash memory 1522, or storage device 1554.

The communication chips 1506 may enable wired and/or wireless communications for the transfer of data to and from the computer device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1500 may include a plurality of communication chips 1506. For instance, a first communication chip 1506 may be dedicated to shorter range wireless communications such as Wi-Fi and Bluetooth, and a second communication chip 1506 may be dedicated to longer range wireless communications such as GPS, EDGE, GPRS, CDMA, WiMAX, LTE, Ev-DO, and others.

In various implementations, the computer device 1500 may be a laptop, a netbook, a notebook, an ultrabook, a smartphone, a computer tablet, a personal digital assistant (PDA), a desktop computer, smart glasses, or a server. In further implementations, the computer device 1500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

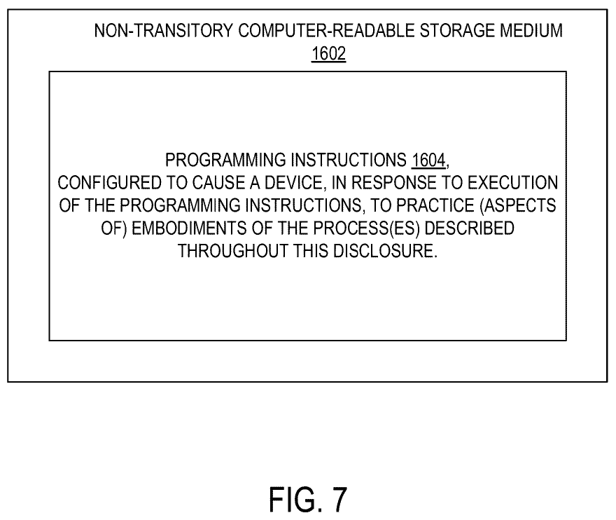

FIG. 7 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1602 may include a number of programming instructions 1604. Programming instructions 1604 may be configured to enable a device, e.g., computer 1500, in response to execution of the programming instructions, to implement (aspects of) system 100, system 200, process flow 300, method 400, or method 500, described above. In alternate embodiments, programming instructions 1604 may be disposed on multiple computer-readable non-transitory storage media 1602 instead. In still other embodiments, programming instructions 1604 may be disposed on computer-readable transitory storage media 1602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
receiving, at the server, a user query;
generating, at the server, a localized context for the user query from a set of local data;
combining, at the server, the user query with the localized context; and
querying, by the server, a machine learning system with the combined user query and localized context.

2. The method of claim 1, wherein generating the localized context further comprises:
clustering similar data together into one or more clusters; and
summarizing, for each of the one or more clusters, the cluster into a summarized data point.

3. The method of claim 2, wherein querying the machine learning system with the combined user query and localized context comprises providing the machine learning system with one or more of the summarized data points.

4. The method of claim 2, wherein clustering similar data together into one or more clusters comprises clustering the similar data together on a semantic and/or syntactic basis.

5. The method of claim 1, further comprising generating, at the server, a prediction based upon a response from the machine learning system to the combined user query and localized context.

6. The method of claim 5, wherein the prediction is a sentiment prediction, a translation, a summarization, an audience targeting, or content generation.

7. A non-transitory computer-readable medium (CRM) comprising instructions that, when executed by a processor of an apparatus, cause the apparatus to:
receive a user query;
generate a localized context for the user query from a set of local data;
combine the user query with the localized context; and
query a machine learning system with the combined user query and localized context.

8. The CRM of claim 7, wherein the instructions generate the localized context by causing the apparatus to:
cluster similar data together into one or more clusters;
summarize, for each of the one or more clusters, the cluster into a summarized data point; and
provide the machine learning system with one or more of the summarized data points.

9. The CRM of claim 8, wherein the instructions cluster similar data together into one or more clusters by causing the apparatus to cluster the similar data together on a semantic and/or syntactic basis.

10. The CRM of claim 7, wherein the instructions are to further cause the apparatus to generate a prediction based upon a response received from the machine learning system to the combined query and localized context.

11. The CRM of claim 10, wherein the prediction is a sentiment prediction, a translation, a summarization, an audience targeting, or content generation.

12. The CRM of claim 7, wherein the apparatus is a mobile device.

13. A system, comprising:
a data storage;
one or more processors; and
instructions stored on the data storage that, when executed by the one or more processors, cause the system to:
receive a user query;
generate a localized context for the user query from a set of local data;
combine the user query with the localized context; and
query a machine learning system with the combined user query and localized context.

14. The system of claim 13, wherein the instructions generate the localized context by causing the system to
cluster similar data together into one or more clusters; and
summarize, for each of the one or more clusters, the cluster into a summarized data point.

15. The system of claim 14, wherein the instructions query the machine learning system with the combined user query and localized context by causing the system to provide the machine learning system with one or more of the summarized data points.

16. The system of claim 14, wherein the instruction cluster similar data together into one or more clusters by causing the system to cluster the similar data together on a semantic and/or syntactic basis.

17. The system of claim 13, wherein the instructions are to further cause the system to generate a prediction based upon a response received from the machine learning system to the combined query and localized context.

18. The system of claim 17, wherein the prediction is a sentiment prediction, a translation, a summarization, an audience targeting, or content generation.

19. The system of claim 13, wherein the system comprises a server.

20. The system of claim 13, wherein the machine learning system is a generative AI system.
